(19) United States
(12) Patent Application Publication
(10) Pub. No.: US 2021/0166191 A1
(43) Pub. Date: Jun. 3, 2021

(54) ADVERTISEMENT SYSTEM, SERVER, AND METHOD OF CONTROLLING ADVERTISEMENT SYSTEM

(71) Applicant: SEIKO EPSON CORPORATION, Tokyo (JP)

(72) Inventors: Tomoyuki KURATA, Matsumoto-shi (JP); Hideki KATO, Matsumoto-shi (JP); Yoshiaki SHIBASAKI, Aizuwakamatsu-shi (JP); Tomomi MIYASAKA, Okaya-shi (JP); Kan MATSUDA, Shiojiri-shi (JP)

(21) Appl. No.: 17/104,683

(22) Filed: Nov. 25, 2020

(30) Foreign Application Priority Data
Nov. 29, 2019 (JP) 2019-216667

(51) Int. Cl. G06Q 10/08; G06Q 30/02

(52) U.S. Cl. CPC G06Q 10/0834; G06Q 10/0838; G06Q 30/0276

(57) ABSTRACT

In an advertisement system that issues a leaflet using a printer of a distributor who distributes a leaflet, the advertisement system includes a server storage unit that stores distributor information about a distributor, a reception unit that receives, from an advertiser, an advertisement request including a distribution condition related to a distribution of the leaflet, an identification unit that identifies the distributor who satisfies the distribution condition included in the advertisement request received by the reception unit based on the distributor information stored in the server storage unit, and a server communication unit that transmits, to the printer of the distributor identified by the identification unit, print data instructing issuance of the leaflet based on the advertisement request received by the reception unit.

The present application is based on, and claims priority from JP Application Serial Number 2019-216667, filed Nov. 29, 2019, the disclosure of which is hereby incorporated by reference herein in its entirety.

### BACKGROUND

### 1. Technical Field

The present disclosure relates to an advertisement system, a server, and a method of controlling the advertisement system.

### 2. Related Art

In the related art, a technique of issuing an advertising medium by a printing apparatus is known. For example, JP-A-2005-259018 discloses a system in which print information is generated based on advertisement design information, printing based on the generated print information is performed at a distribution base of an advertising medium, and a leaflet is issued at the distribution base.

An example of the system that issues the advertising medium, as disclosed in JP-A-2005-259018, includes a system that issues the advertising medium by the printing apparatus of a distributor who distributes the advertising medium. However, in this type of system, there is no mechanism of automatically identifying the distributor according to the distribution condition of the advertiser, and there is a problem that the distribution of the advertising medium that meets the distribution condition of the advertiser cannot be easily performed.

### SUMMARY

According to an aspect of the present disclosure, in an advertisement system that issues an advertising medium by a printing apparatus of a distributor who distributes the advertising medium, the advertisement system includes a storage unit that stores distributor information about the distributor, a reception unit that receives, from an advertiser, an advertisement request including a distribution condition related to a distribution of the advertising medium, a identification unit that identifies the distributor that satisfies the distribution condition included in the advertisement request received by the reception unit based on the distributor information stored in the storage unit, and a transmission unit that transmits, to the printing apparatus of the distributor identified by the identification unit, print data instructing issuance of the advertising medium based on the advertisement request received by the reception unit.

The above advertisement system may have a configuration in which the distributor information includes distributable area information indicating a distributable area in which the distributor is enabled to distribute the advertising medium, wherein the distribution condition includes a distribution desired area that is an area in which the advertiser desires the distributor to distribute the advertising medium, and wherein the identification unit identifies the distributor information including the distributable area information indicating the distributable area including the distribution desired area.

The above advertisement system may have a configuration in which the distributor information includes distributable date information indicating a distributable date that is a date when the distributor is enabled to distribute the advertising medium, wherein, the distribution condition includes a distribution desired period that is a period in which the advertiser desires the distributor to distribute the advertising medium, and wherein the identification unit identifies the distributor information including the distributable date information indicating the distributable date corresponding to at least part of the distribution desired period.

The above advertisement system may have a configuration in which the distributor information includes rank information indicating a rank of the distributor according to a distribution record, wherein the identification unit identifies the distributor information by giving higher priority to the distributor information in which the rank indicated by the rank information is higher.

The above advertisement system may include a rank determination unit that determines the rank based on at least one of the number of sheets actually distributed by the distributor with respect to a target number of sheets to be distributed, the number of days by which a start of a distribution of the advertising medium is delayed, and a total number of sheets distributed by the distributor in the past.

The above advertisement system may include a presentation unit that presents, to the advertiser, the distribution condition which enables the identification unit to identify the distributor information that satisfies the distribution condition when the identification unit is not enabled to identify the distributor information that satisfies the distribution condition.

According to another aspect of the present disclosure, in a server that issues an advertising medium by a printing apparatus of a distributor who distributes the advertising medium, the server includes a storage unit that stores distributor information about the distributor, a reception unit that receives, from an advertiser, an advertisement request including a distribution condition related to a distribution of the advertising medium, a identification unit that identifies the distributor that satisfies the distribution condition included in the advertisement request received by the reception unit based on the distributor information stored in the storage unit, and a transmission unit that transmits, to the printing apparatus of the distributor identified by the identification unit, print data instructing issuance of the advertising medium based on the advertisement request received by the reception unit.

According to still another aspect of the present disclosure, in a method of controlling an advertisement system that issues an advertising medium by a printing apparatus of a distributor who distributes the advertising medium, the method includes storing distributor information about the distributor, receiving, from an advertiser, an advertisement request including a distribution condition related to a distribution of the advertising medium, identifying, from the stored distributor information, the distributor that satisfies the distribution condition included in the received advertisement request, and transmitting, to the printing apparatus of the identified distributor, print data instructing issuance of the advertising medium based on the received advertisement request.

### BRIEF DESCRIPTION OF THE DRAWINGS

FIG. 1 is a diagram showing a configuration of an advertisement system.

FIG. 2A is a first half of a diagram showing a configuration of each device included in the advertisement system.

FIG. 2B is a second half of the diagram showing the configuration of each device included in the advertisement system.

FIG. 3 is a diagram showing an example of a distributor management database.

FIG. 4 is a diagram showing an example of a request information management database.

FIG. 5 is a diagram showing an example of a distribution history management database.

FIG. 6 is a flowchart showing the operation of a rank determination unit.

FIG. 7A is a first half of a flowchart showing the operation of the advertisement system.

FIG. 7B is a second half of the flowchart showing the operation of the advertisement system.

FIG. 8 is a flowchart showing the operation of a posting server.

FIG. 9 is a diagram for explaining identification of distributor information.

### DESCRIPTION OF EXEMPLARY EMBODIMENTS

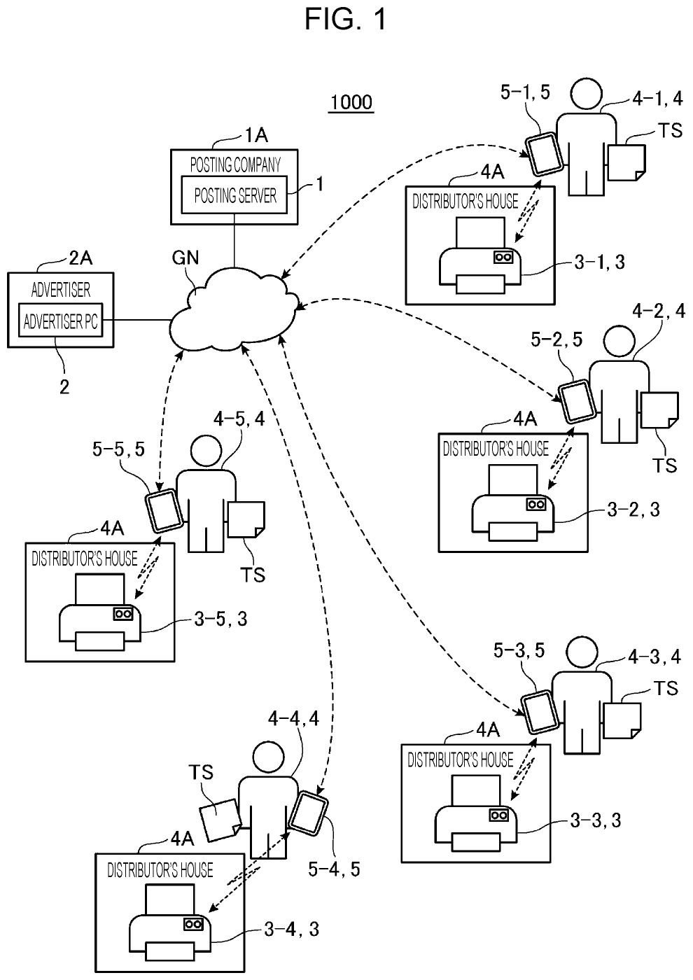

FIG. 1 is a diagram showing a configuration of an advertisement system 1000.

The advertisement system 1000 is a system used by a posting company 1A. The posting company 1A is a company that performs a business related to distribution of a leaflet TS in which the advertisements of products and services of an advertiser 2A are placed. The leaflet TS is a diagram showing an example of an advertising medium.

As shown in FIG. 1, the advertisement system 1000 includes a posting server 1. The posting server 1 corresponds to an example of a server. The posting server 1 is a server apparatus managed by the posting company 1A and is connected to a global network GN.

In each figure, the posting server 1 is represented by one block, but this does not necessarily mean that the posting server 1 is configured by a single server apparatus. For example, the posting server 1 may be configured to include a plurality of server apparatuses having different processing contents.

As shown in FIG. 1, the advertisement system 1000 includes a printer 3. The printer 3 corresponds to an example of a printing apparatus. The printer 3 of the present embodiment is an ink jet type printing apparatus, and is a stationary printing apparatus provided in the residence of the distributor 4 who distributes the leaflet TS by concluding a predetermined contract with the posting company 1A. In the following description, the residence of the distributor 4 is referred to as a “distributor's house”, and the reference numeral “4A” is attached. The printer 3 provided in the distributor's house 4A may be the property of the distributor 4 or may be lent by the posting company 1A.

In FIG. 1, five distributors 4 are illustrated. In the present embodiment, the assigned area in which distributors 4-1, 4-2, 4-3, and 4-4 distribute the leaflet TS is “area A”, and the assigned area in which the distributor 4-5 distributes the leaflet TS is “area B” among the five distributors 4 shown in FIG. 1. Although illustration is omitted, the distributors 4 concluding a predetermined contract with the posting company 1A include the distributors 4 who are assigned areas other than “area A” and “area B”. The number of the distributors 4 assigned “area A” and the number of the distributors 4 assigned “area B” are merely an example, and may be larger or smaller.

As shown in FIG. 1, the advertisement system 1000 includes a tablet terminal 5 used by the distributor 4. The tablet terminal 5 is, for example, a tablet-type terminal device in which a touch panel 53 is provided on the front face in a wide area, and communicates with the printer 3 to control the printer 3. Further, the tablet terminal 5 is connected to the global network GN to communicate with the posting server 1. The tablet terminal 5 used by the distributor 4 may be the property of the distributor 4 or may be lent by the posting company 1A. Further, in the present embodiment, the case where the one printer 3 communicates with the one tablet terminal 5 is illustrated, but the number of the printers 3 that communicate with the tablet terminal 5 may be plural.

In the present embodiment, the distributor 4-1 operates a tablet terminal 5-1 to issue the leaflet TS with the printer 3-1. Further, the distributor 4-2 operates a tablet terminal 5-2 to issue the leaflet TS with a printer 3-2. Further, the distributor 4-3 operates a tablet terminal 5-3 to issue the leaflet TS with the printer 3-3. The distributor 4-4 operates the tablet terminal 5-4 to issue the leaflet TS with the printer 3-4. The distributor 4-5 operates the tablet terminal 5-5 to issue the leaflet TS with the printer 3-5.

As shown in FIG. 1, an advertiser PC 2 which is a personal computer (PC) operated by the advertiser 2A is connected to the global network GN. A browser 220B is installed in advance in the advertiser PC 2. The advertiser 2A opens the browser 220B installed in the advertiser PC 2, accesses the Web page provided by the posting company 1A, and requests the posting company 1A to distribute the leaflet TS via the Web page. Note that the number of advertiser PCs 2 connected to the global network GN is merely an example, and is not limited to one, and may be plural.

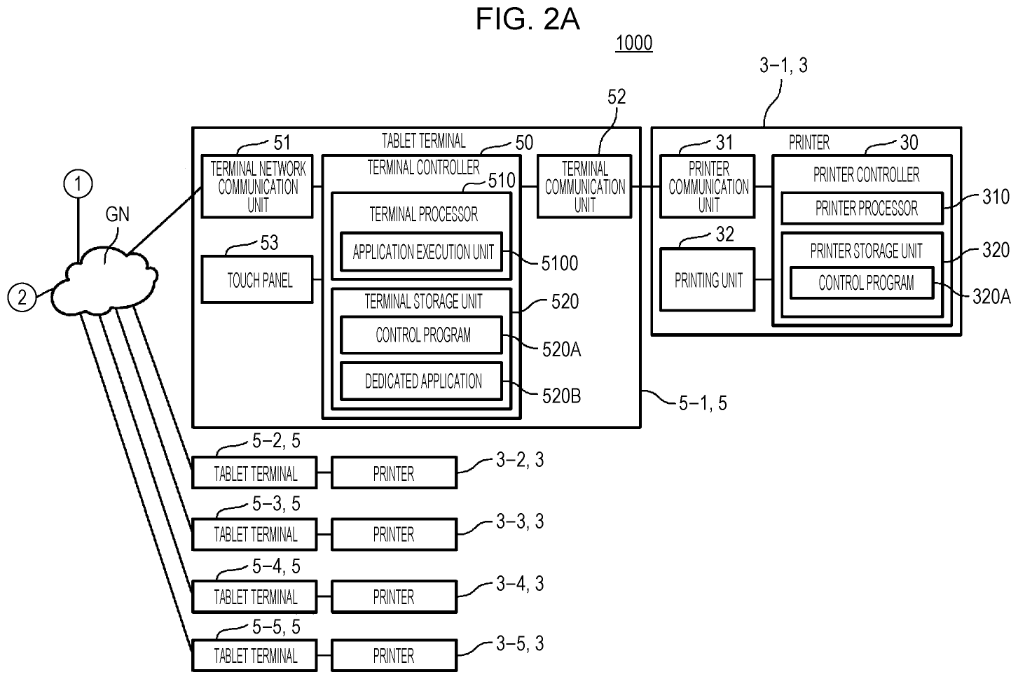

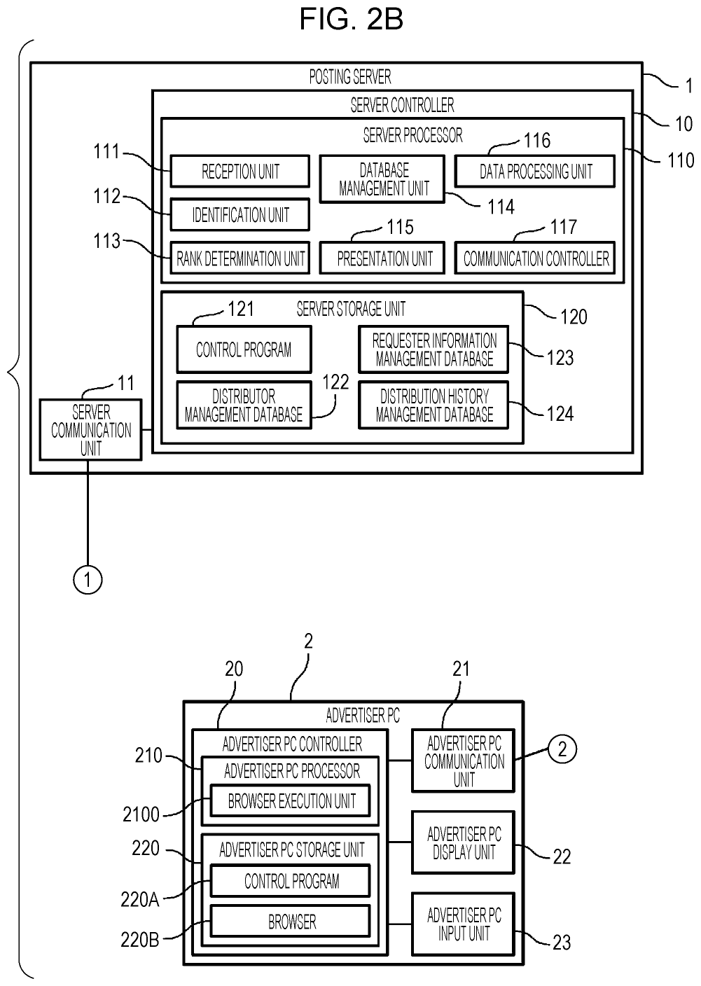

FIGS. 2A and 2B are block diagrams showing a functional configuration of each device included in the advertisement system 1000.

First, the tablet terminal 5 will be described. The tablet terminal 5 includes a terminal controller 50, a terminal network communication unit 51, a terminal communication unit 52, and the touch panel 53.

The terminal controller 50 includes a terminal processor 510 that is a processor, such as a CPU and an MPU, that executes programs, and a terminal storage unit 520, and controls respective units of the tablet terminal 5. The terminal controller 50 performs various processes in cooperation with hardware and software so that the terminal processor 510 reads a control program 520A stored in the terminal storage unit 520 to execute the processes. A dedicated application program is installed in advance in the tablet terminal 5. In the following description, the dedicated application program is simply referred to as a “dedicated application” and is denoted by “520B”. The dedicated application 520B is an application program that is read from the terminal storage unit 520 and executed by the terminal processor 510 to cause the terminal controller 50 to function as an application execution unit 5100. The function of the application execution unit 5100 will be described later.

The terminal storage unit 520 has a storage area in which a program to be executed by the terminal processor 510 and data processed by the terminal processor 510 are stored. The terminal storage unit 520 stores the control program 520A to be executed by the terminal processor 510, the dedicated application 520B, and other various pieces of data. The terminal storage unit 520 has a non-volatile storage area in which programs and data are stored in a non-volatile manner. Further, the terminal storage unit 520 may include a volatile storage area, and may constitute a work area in which a program to be executed by the terminal processor 510 and data to be processed are temporarily stored.

The terminal network communication unit 51 includes communication hardware according to a predetermined communication standard, and communicates with the posting server 1 according to a predetermined communication standard under the control of the terminal controller 50.

The terminal communication unit 52 is composed of communication hardware according to a predetermined communication standard, and communicates with the printer 3 under the control of the terminal controller 50. The communication standard of communication performed between the tablet terminal 5 and the printer 3 is a wireless communication standard in this embodiment, but may be a wire communication standard.

The touch panel 53 includes a display panel such as a liquid crystal display panel and a touch sensor that is provided so as to overlap with or provided integrally with the display panel. The display panel displays various images under the control of the terminal controller 50. The touch sensor detects a touch operation to output the result to the terminal controller 50. The terminal controller 50 executes a process corresponding to the touch operation based on the input from the touch sensor.

As described above, the terminal controller 50 functions as the application execution unit 5100. Upon receiving the distribution request notification from the posting server 1, the application execution unit 5100 transmits the print data included in the distribution request notification to the printer 3. The print data is data for instructing the printer 3 to issue the leaflet TS, and includes advertisement image data 1235, which will be described later, and various commands related to printing. The distribution request notification includes, as information, the distribution start date and time which is a date and time when the distributor 4 is to start distributing the leaflet TS, the distribution end date and time which is a date and time when the distributor 4 is to end distributing the leaflet TS, and the target number of distribution sheets of sheets which is the target number of sheets to be distributed by the distributor 4 in the distribution period of the leaflet TS, in addition to the print data. The distribution period of the leaflet TS indicated by the distribution request notification is a period from the distribution start date and time to the distribution end date and time.

In addition, the application execution unit 5100 transmits, to the posting server 1, a distribution start notification indicating that the distributor 4 has started distributing the leaflet TS. The application execution unit 5100 displays, on the touch panel 53, for example, a software button for confirming that distribution of the leaflet TS is started, and when the software button is operated, the distribution start notification is transmitted to the posting server 1. The distribution start notification includes a distributor ID 1221 described later, a request information ID 1231 described later, and information indicating the date and time when distribution of the leaflet TS is started.

In addition, the application execution unit 5100 transmits, to the posting server 1, a distribution end notification indicating that the distributor 4 has completed distribution of the target number of distribution sheets of the leaflet TS. The application execution unit 5100 displays, on the touch panel 53, for example, a software button for confirming that distribution of the target number of distribution sheets of the leaflet TS has been completed, and when the software button is operated, the distribution end notification is transmitted to posting server 1. The distribution end notification includes the distributor ID 1221, the request information ID 1231, and the date and time when distribution of the target number of distribution sheets of the leaflet TS has been completed.

The application execution unit 5100 transmits a distribution certification notification to the posting server 1. The distribution certification notification includes information serving as proof that the leaflet TS has been distributed. Examples of the proof information include position information input from a GPS unit (not shown), shooting data of a camera (not shown), and the like. For example, when the software button for confirming the transmission of the distribution certification notification is operated, the application execution unit 5100 transmits the distribution certification notification to the posting server 1. The distribution certification notification includes, for each distribution destination, shooting data of the distribution destination, position information of the distribution destination, and the like. As a result, the posting server 1 can ascertain the number of sheets of the leaflet TS distributed at the time of receiving the distribution certification notification based on the number of pieces of shooting data and the number of pieces of position information included in the received distribution certification notification. The distribution certification notification further includes the distributor ID 1221 and the request information ID 1231.

Next, the printer 3 will be described. The printer 3 includes a printer controller 30, a printer communication unit 31, and a printing unit 32.

The printer controller 30 includes a printer processor 310, which is a processor, such as a CPU and an MPU, that executes programs, and a printer storage unit 320, and controls respective units of the child printer 3. The printer controller 30 performs various processes in cooperation with hardware and software so that the printer processor 310 reads a control program 320A stored in the printer storage unit 320 to execute the processes.

The printer storage unit 320 has a storage area in which a program to be executed by the printer processor 310 and data processed by the printer processor 310 are stored. The printer storage unit 320 stores the control program 320A executed by the printer processor 310 and other various pieces of data. The printer storage unit 320 has a non-volatile storage area in which programs and data are stored in a non-volatile manner. Further, the printer storage unit 320 may include a volatile storage area, and may constitute a work area in which a program to be executed by the printer processor 310 and data to be processed are temporarily stored.

The printer communication unit 31 is composed of communication hardware according to a predetermined communication standard, and communicates with the tablet terminal 5 under the control of the printer controller 30.

The printing unit 32 has a configuration related to a printing system including an ink jet head that ejects ink onto a print medium, a carriage for scanning the ink jet head in the scanning direction, a carriage drive motor for driving the carriage, a transport unit that transports a print medium, a supply mechanism that supplies the ink to the ink jet head, and the like. The printing unit 32 prints an image on a print medium under the control of the printer controller 30. The printing unit 32 of the present embodiment prints the advertisement image indicated by the advertisement image data 1235 on the print medium based on the print data transmitted from the posting server 1 via the tablet terminal 5, and issues the leaflet TS.

Next, the advertiser PC 2 will be described. The advertiser PC 2 includes an advertiser PC controller 20, an advertiser PC communication unit 21, an advertiser PC display unit 22, and an advertiser PC input unit 23.

The advertiser PC controller 20 includes an advertiser PC processor 210, which is a processor, such as a CPU and an MPU, that executes programs, and an advertiser PC storage unit 220, and controls respective units of the advertiser PC 2. The advertiser PC controller 20 performs various processes in cooperation with hardware and software so that the advertiser PC processor 210 reads a control program 220A stored in the advertiser PC storage unit 220 to execute the processes. The browser 220B is installed in advance in the advertiser PC 2. The browser 220B is read from the advertiser PC storage unit 220 by the advertiser PC processor and executed to cause the advertiser PC controller 20 to function as a browser execution unit 2100. The function of the browser execution unit 2100 will be described later.

The advertiser PC storage unit 220 has a storage area in which a program executed by the advertiser PC processor 210 and data processed by the advertiser PC processor 210 are stored. The advertiser PC storage unit 220 stores a control program 220A executed by the advertiser PC processor 210, the browser 220B, and other various pieces of data. The advertiser PC storage unit 220 has a non-volatile storage in which programs and data are stored in a non-volatile manner. Further, the advertiser PC storage unit 220 may include a volatile storage area, and may constitute a work area in which a program to be executed by the advertiser PC processor 210 and data to be processed are temporarily stored.

The advertiser PC communication unit 21 includes communication hardware according to a predetermined communication standard, and communicates with the posting server 1 according to a predetermined communication standard under the control of the advertiser PC controller 20.

The advertiser PC display unit 22 includes a display panel, and displays various pieces of information on the display panel under the control of the advertiser PC controller 20.

The advertiser PC input unit 23 includes a keyboard, a mouse, and another input section, and detects a user operation on the input section to output the detected operation to the advertiser PC controller 20. The advertiser PC controller 20 executes a process corresponding to the user operation on the input section based on the input from the advertiser PC input unit 23.

As described above, the advertiser PC controller 20 functions as the browser execution unit 2100. The browser execution unit 2100 accesses the URL of a Web page for requesting the distribution of the leaflet TS and receives the HTML file for displaying the Web page from the posting server 1 through the advertiser PC communication unit 21. The browser execution unit 2100 displays the Web page on the advertiser PC display unit 22 based on the received HTML file.

The browser execution unit 2100 receives the input of the distribution condition of the leaflet TS through the Web page displayed by the advertiser PC display unit 22. The distribution conditions input to the Web page includes the distribution desired period that is a period in which the advertiser 2A desires the distributor to distribute the leaflet TS, the desired number of distribution sheets that is the number of sheets, of the leaflet TS, which the advertiser 2A desires the distributor to distribute in the distribution desired period, and the distribution desired area that is an area in which the advertiser 2A desires the distributor to distribute of the leaflet TS. The browser execution unit 2100 receives the inputs of an advertiser ID 1233, address information 1234, and the advertisement image data 1235 in addition to the distribution condition of the leaflet TS through the Web page displayed by the advertiser PC display unit 22. The advertiser ID 1233, the address information 1234, and the advertisement image data 1235 will be described later.

Upon receiving the inputs of the distribution condition of the leaflet TS, the advertiser ID 1233, the address information 1234, and the advertisement image data 1235, the browser execution unit 2100 transmits request information 1232 to the posting server 1 through the advertiser PC communication unit 21. The browser execution unit 2100 makes an advertisement request to the posting server 1 by transmitting the request information 1232. The advertisement request is a request for distributing the leaflet TS, that the advertiser 2A makes to the posting server 1. The request information 1232 includes information indicating the distribution condition received by the browser execution unit 2100, the advertiser ID 1233, the address information 1234, and the advertisement image data 1235.

Next, the posting server 1 will be described. The posting server 1 includes a server controller 10 and a server communication unit 11. The server communication unit 11 corresponds to an example of a transmission unit.

The server controller 10 includes a server processor 110, which is a processor, such as a CPU and an MPU, that executes programs, and a server storage unit 120, and controls respective units of the posting server 1. The server storage unit 120 corresponds to an example of the storage unit. The server controller 10 executes various processes in cooperation with hardware and software so that the server processor 110 reads a control program 121 stored in the server storage unit 120 and executes the processes. The server processor 110 reads out and executes the control program 121, so that the server controller 10 functions as a reception unit 111, an identification unit 112, a rank determination unit 113, a database management unit 114, a presentation unit 115, a data processing unit 116, and a communication controller 117. Details of these functional units will be described later.

The server storage unit 120 has a storage area in which a program executed by the server processor 110 and data processed by the server processor 110 are stored. The server storage unit 120 stores the control program 121 executed by the server processor 110, a distributor management database 122, a request information management database 123, a distribution history management database 124, and other various pieces of data. The server storage unit 120 has a non-volatile storage area in which programs and data are stored in a non-volatile manner. Further, the server storage unit 120 may include a volatile storage area, and may constitute a work area in which a program to be executed by the server processor 110 and data to be processed are temporarily stored.

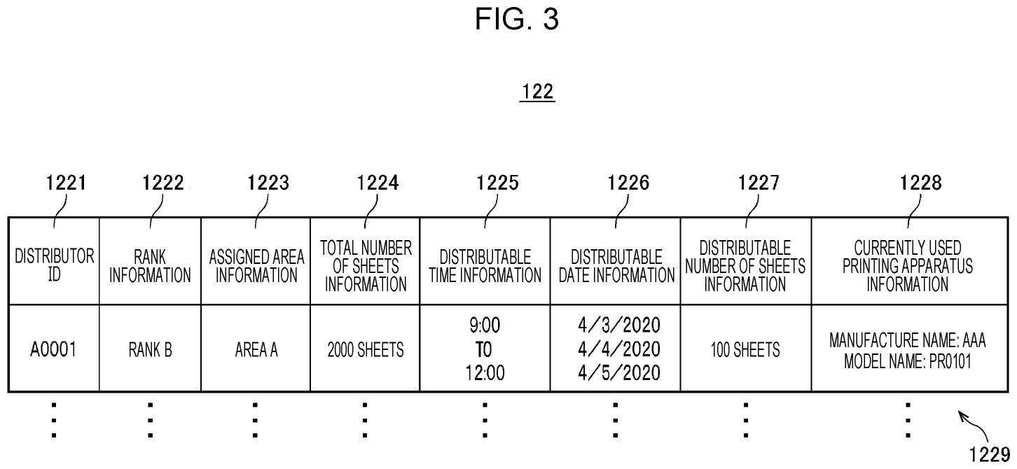

FIG. 3 is a diagram showing an example of the distributor management database 122. The distributor management database 122 is a database that stores, as a record, distributor information 1229, which is information about the distributor 4. One record of the distributor management database 122, that is, the one distributor information 1229 stored in the distributor management database 122 includes the distributor ID 1221, rank information 1222, assigned area information 1223, total number of sheets information 1224, and distributable time information 1225, distributable date information 1226, distributable number of sheets information 1227, and currently used printing apparatus information 1228. The assigned area information 1223 corresponds to an example of distributable area information.

The distributor ID 1221 is identification information for identifying the distributor 4, and is assigned to the distributor 4 when a record is newly stored in the distributor management database 122, for example.

The rank information 1222 is information indicating the rank of the distributor 4 according to the distribution record. The rank indicated by the rank information 1222 is one of five ranks, that is, rank A, rank B, rank C, rank D, and rank E. In this embodiment, rank A, rank B, rank C, rank D, and rank E indicate the evaluation of the distributor 4 based on the distribution record in five levels. In rank A, rank B, rank C, rank D, and rank E, rank A represents the higher evaluation of the distributor 4, that is, the highest rank, and rank E represents the lowest evaluation of the distributor 4, that is, the lowest rank. The rank indicated by the rank information 1222 is appropriately updated by the database management unit 114 based on the rank determined by the rank determination unit 113.

The assigned area information 1223 is information indicating the assigned area in which the distributor 4 distributes the leaflet TS, and also information indicating the area in which the distributor 4 can distribute the leaflet TS.

The total number of sheets information 1224 is information indicating the total number of sheets of the leaflet TS distributed by the distributor 4 in the past. The total number of sheets indicated by the total number of sheets information 1224 is updated by the database management unit 114 at a predetermined timing.

The distributable time information 1225 is information indicating the distributable time, which is a time at which the distributor 4 can distribute the leaflet TS in one day.

The distributable date information 1226 is information indicating a distributable date that is a date on which the distributor 4 can distribute the leaflet TS in a predetermined period. The distributable date indicated by the distributable date information 1226 is set or updated at predetermined timing by the function of the dedicated application 520B when the distributor 4 operates the tablet terminal 5, for example. The distributable date indicated by the distributable date information 1226 is updated by the database management unit 114 when the data processing unit 116 stores the record in the distribution history management database 124.

The distributable number of sheets information 1227 is information indicating the distributable number of sheets, which is the number of sheets of the leaflet TS that the distributor 4 can distribute. The distributable number of sheets indicated by the distributable number of sheets information 1227 is the number of sheets of the leaflet TS that can be distributed at the distributable time indicated by the distributable time information 1225. The distributable number of sheets information 1227 indicates the distributable time indicated by the distributable time information 1225 and the distributable number of sheets according to the combination of the manufacturer name of the printer 3 and the model name of the printer 3 indicated by the currently used printing apparatus information 1228.

The currently used printing apparatus information 1228 is information about the printer 3 used by the distributor 4 indicated by the distributor ID 1221 of the same record. The information about the printer 3 indicates the combination of the manufacturer name of the printer 3 and the model name of the printer 3.

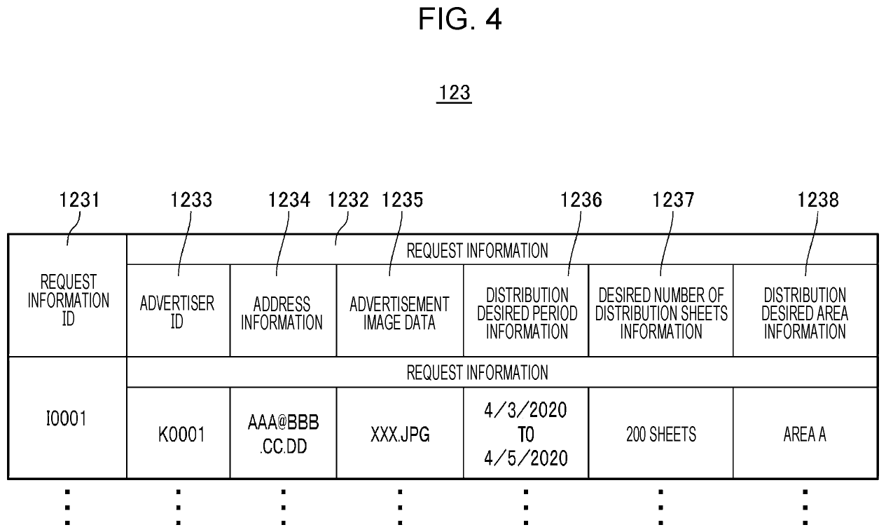

FIG. 4 is a diagram showing an example of the request information management database 123. As shown in FIG. 4, one record in the request information management database 123 includes the request information ID 1231 and the request information 1232.

The request information ID 1231 is identification information for identifying the request information 1232 received from the advertiser PC 2.

When the reception unit 111 receives the request information 1232 from the advertiser PC 2, the data processing unit 116 of the server controller 10 generates the request information ID 1231 to associate the generated request information ID 1231 with the received request information 1232. Then, the data processing unit 116 stores, in the request information management database 123, a record in which the request information 1232 is associated with the request information ID 1231.

The request information 1232 includes the advertiser ID 1233, the address information 1234, the advertisement image data 1235, distribution desired period information 1236, desired number of distribution sheets information 1237, and distribution desired area information 1238.

The advertiser ID 1233 is identification information for identifying the advertiser 2A, and is notified to the advertiser 2A in advance by a predetermined method.

The address information 1234 is address information for transmitting predetermined information to the advertiser PC 2, that is, for example, information such as am e-mail address.

The advertisement image data 1235 is image data of an advertisement image indicating the advertisement of the advertiser 2A. The advertisement image data 1235 is generated by a predetermined application program installed in the advertiser PC 2.

The distribution desired period information 1236 is information indicating a distribution desired period.

The desired number of distribution sheets information 1237 is information indicating the desired number of distribution sheets.

The distribution desired area information 1238 is information indicating a distribution desired area.

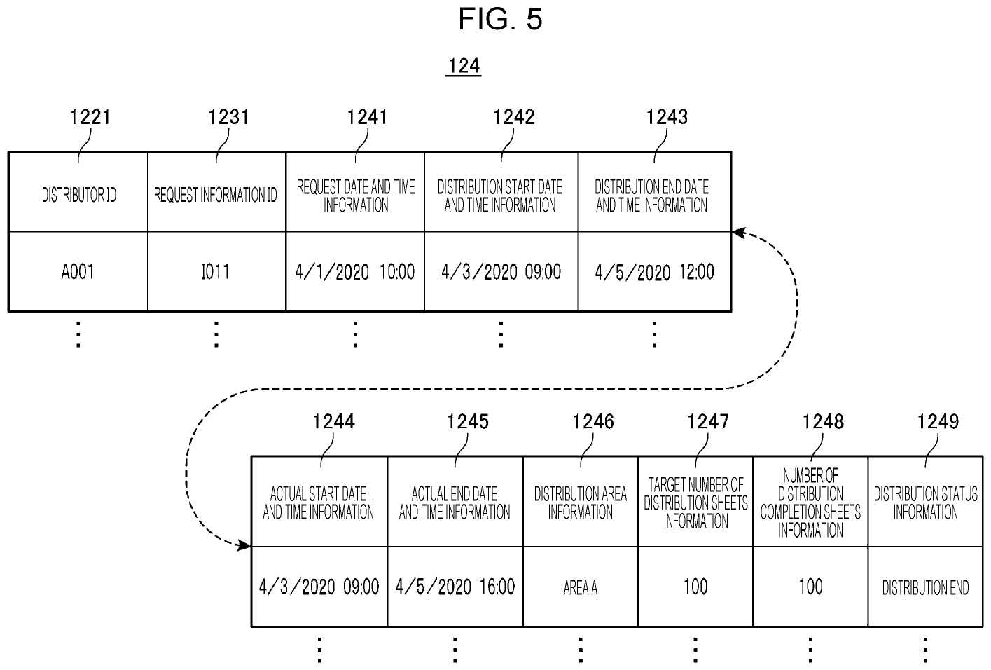

FIG. 5 is a diagram showing an example of the distribution history management database 124. As shown in FIG. 5, one record in the distribution history management database 124 includes the distributor ID 1221, the request information ID 1231, request date and time information 1241, distribution start date and time information 1242, distribution end date and time information 1243, actual start date and time information 1244, actual end date and time information 1245, and distribution area information 1246, target number of distribution sheets information 1247, number of distribution completion sheets information 1248, and distribution status information 1249.

The request date and time information 1241 is information indicating the date and time when the advertiser 2A made the advertisement request.

The distribution start date and time information 1242 is information indicating the distribution start date and time. The distribution start date and time indicated by the distribution start date and time information 1242 is set by the data processing unit 116 based on the distributable time information 1225 and the distributable date information 1226 of the distributor information 1229 associated with the same distributor ID 1221 and the distribution desired period information 1236 of the request information 1232 associated with the same request information ID 1231.

The distribution end date and time information 1243 is information indicating the distribution end date and time. The distribution end date and time indicated by the distribution end date and time information 1243 is set by the data processing unit 116 based on the distributable time information 1225 and the distributable date information 1226 of the distributor information 1229 associated with the same distributor ID 1221 and the distribution desired period information 1236 of the request information 1232 associated with the same request information ID 1231.

The actual start date and time information 1244 is information indicating the date and time when the distributor 4 actually starts distributing the leaflet TS. When the distribution start notification is received from the tablet terminal 5, the database management unit 114 sets the date and time indicated by the actual start date and time information 1244 to the date and time including the received distribution start notification for the record of the distributor ID 1221 included in the distribution start notification.

The actual end date and time information 1245 is information indicating the date and time when the distributor 4 actually ended the distribution of the leaflet TS. When the distribution end notification is received from the tablet terminal 5, the database management unit 114 sets the distribution end date and time indicated by the distribution end date and time information 1243 to the date and time included in the received distribution end notification for the record of the distributor ID 1221 included in the distribution end notification. In addition, when the current date and time passes the date and time indicated by the distribution end date and time information 1243, the database management unit 114 sets the date and time indicated by the actual end date and time information 1245 to the distribution end date and time indicated by the distribution end date and time information 1243 associated in the same record.

The distribution area information 1246 is information indicating an area where the distributor 4 distributes the leaflet TS.

The target number of distribution sheets information 1247 is information indicating the target number of distribution sheets.

The number of distribution completion sheets information 1248 is information indicating the number of sheets of the leaflet TS actually distributed by the distributor 4 during the distribution period of the leaflet TS. When the current date and time is the distribution period of the leaflet TS, the number of sheets indicated by the number of distribution completion sheets information 1248 is appropriately updated by the database management unit 114. When receiving the distribution certification notification from the tablet terminal 5, the database management unit 114 updates cumulatively the number of distribution completion sheets indicated by the number of distribution completion sheets information 1248 based on the received distribution certification notification for the record of the distributor ID 1221 included in the distribution certification notification. When the distribution status that the distribution status information 1249 indicates the distribution is completed, the database management unit 114 does not update the number of distribution completion sheets information 1248 even when the distribution certification notification is received.

The distribution status information 1249 is information indicating the distribution status of the leaflet TS of the distributor 4. The distribution status indicated by the distribution status information 1249 is one of “before distribution”, “during distribution”, and “end of distribution”, and is appropriately updated by the database management unit 114. Upon receiving the distribution start notification from the tablet terminal 5, the database management unit 114 updates the distribution status from “before distribution” to “during distribution”. Further, the database management unit 114 updates the distribution status from “during distribution” to “end of distribution” when the tablet terminal 5 receives the distribution end notification or when the distribution end date and time is set in the actual end date and time information 1245.

The server communication unit 11 includes communication hardware according to a predetermined communication standard, and communicates with a device connected to the global network GN according to the predetermined communication standard under the control of the server controller 10. The devices connected to the global network GN here include the advertiser PC 2 and the tablet terminal 5.

As described above, the server controller 10 functions as the reception unit 111, the identification unit 112, the rank determination unit 113, the database management unit 114, the presentation unit 115, the data processing unit 116, and the communication controller 117.

The reception unit 111 receives the advertisement request from the advertiser 2A by receiving the request information 1232 from the advertiser PC 2 through the server communication unit 11. The reception unit 111 outputs the received request information 1232 to the data processing unit 116. The data processing unit 116 generates the request information ID 1231, and generates a record in which the generated request information ID 1231 and the request information 1232 input from the reception unit 111 are associated with each other, to store the record in the request information management database 123.

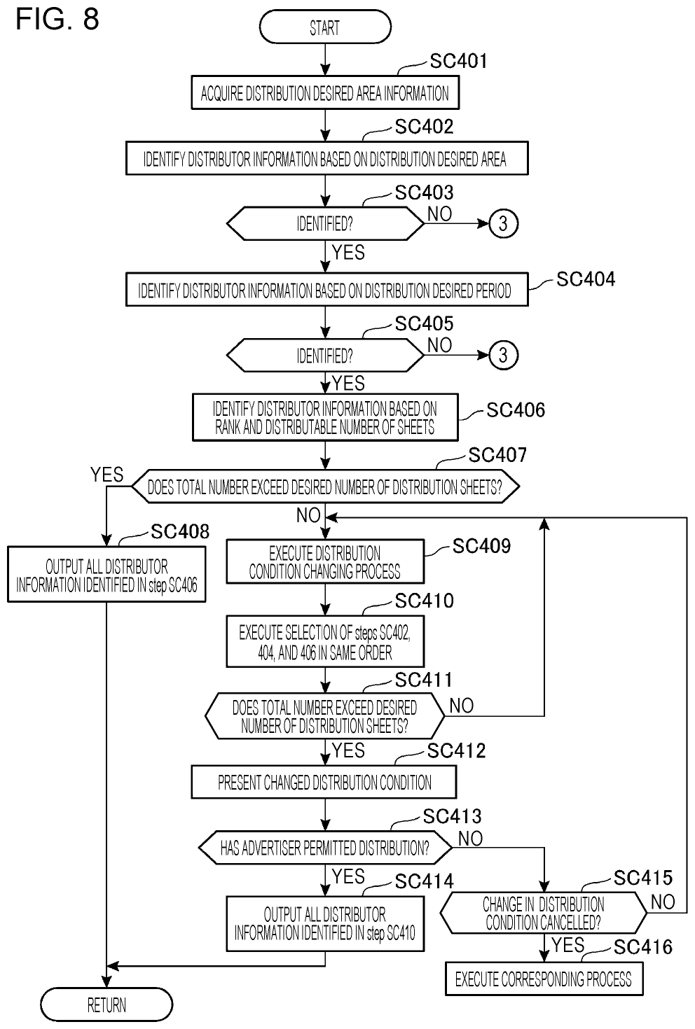

The identification unit 112 performs the operation of FIG. 8 and identifies, from the distributor management database 122, the distributor information 1229 corresponding to the distribution condition, of the leaflet TS, included in the advertisement request received by the reception unit 111.

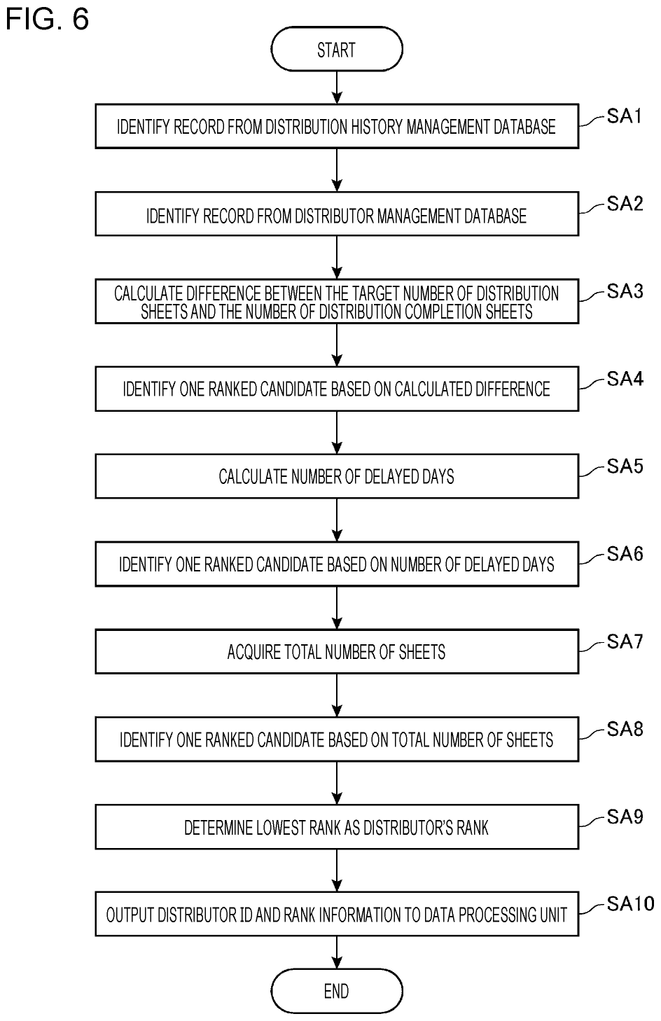

The rank determination unit 113 performs the operation of FIG. 6 and determines the rank according to the distribution record for each distributor 4. The database management unit 114 updates the rank information 1222 of the distributor information 1229 based on the rank determined by the rank determination unit 113.

The database management unit 114 appropriately updates various kinds of information included in the record with respect to the record that each of the distributor management database 122, the request information management database 123, and the distribution history management database 124 stores.

The presentation unit 115 performs the operation of FIG. 8 and presents the distribution condition different from the distribution condition input by the advertiser 2A to the advertiser 2A.

The data processing unit 116 generates the record to be stored in various databases, stores the generated records, deletes the record from the database, generates the print data, and generates the distribution request notification.

The communication controller 117 transmits the distribution request notification generated by the data processing unit 116 to the tablet terminal 5.

The operation of the rank determination unit 113 will be described in detail with reference to FIG. 6. FIG. 6 is a flowchart showing the operation of the rank determination unit 113.

The rank determination unit 113 starts the operation of the flowchart shown in FIG. 6 when predetermined timing arrives.

The rank determination unit 113 identifies, from the distribution history management database 124, one record including the actual end date and time information 1245 in which the date and time is set (step SA1).

Next, the rank determination unit 113 identifies, from the distributor management database 122, a record having the distributor ID 1221 that is the same as the distributor ID 1221 included in the record identified in step SA1 (step SA2).

Next, the rank determination unit 113 calculates the difference between the target number of distribution sheets and the number of distribution completion sheets based on the target number of distribution sheets information 1247 and the number of distribution completion sheets information 1248 of the record identified in step SA1 (step SA3).

Next, the rank determination unit 113 identifies one ranked candidate for the distributor 4 from among rank A, rank B, rank C, rank D, and rank E based on the difference, between the target number of distribution sheets and the number of distribution completion sheets, that is calculated in step SA3 (step SA4).

In step SA4, when the difference between the target number of distribution sheets and the number of distribution completion sheets is Y1 or less, the rank determination unit 113 identifies rank A as a ranked candidate for the distributor 4. In step SA4, when the difference between the target number of distribution sheets and the number of distribution completion sheets is more than Y1 and Y2 or less, the rank determination unit 113 identifies rank B as a ranked candidate for the distributor 4. Note that Y2 is larger than Y1. In step SA4, when the difference between the target number of distribution sheets and the number of distribution completion sheets is more than Y2 and Y3 or less, the rank determination unit 113 identifies rank C as a ranked candidate for the distributor 4. Note that Y3 is larger than Y2. In step SA4, when the difference between the target number of distribution sheets and the number of distribution completion sheets is more than Y3 and Y4 or less, the rank determination unit 113 determines rank D as a ranked candidate for the distributor 4. Note that Y4 is larger than Y3. Further, in step SA4, when the difference between the target number of distribution sheets and the number of distribution completion sheets is more than Y4, the rank determination unit 113 determines rank E as a ranked candidate for the distributor 4.

In this way, in step SA4, the smaller the difference between the target number of distribution sheets and the number of distribution completion sheets is, the higher rank the rank determination unit 113 identifies.

Next, the rank determination unit 113 calculates the number of days by which the start of the distribution of the leaflet TS by the distributor 4 has delayed based on the distribution start date and time information 1242 of the record identified in step SA1 and the actual start date and time information 1244 (step SA5). In the following description, the number of days by which the start of the distribution has delayed is referred to as the “number of delayed days”.

Next, the rank determination unit 113 identifies one ranked candidate for the distributor 4 from among rank A, rank B, rank C, rank D, and rank E based on the number of delayed days calculated in step SA5 (step SA6).

In step SA6, when the number of delayed days is D1 days or less, the rank determination unit 113 identifies rank A as a ranked candidate for the distributor 4. In step SA6, when the number of delayed days is more than Dl days and less than or equal to D2 days, the rank determination unit 113 identifies rank B as a ranked candidate for the distributor 4. Note that D2 is larger than D1. In addition, in step SA6, when the number of delayed days is more than D2 days and less than or equal to D3 days, the rank determination unit 113 identifies rank C as a ranked candidate for the distributor 4. Note that D3 is larger than D2. Further, in step SA6, when the number of delayed days is more than D3 days and less than or equal to D4 days, the rank determination unit 113 identifies rank D as a ranked candidate for the distributor 4. Note that D4 is larger than D3. In addition, in step SA6, when the number of delayed days is more than D4 days, the rank determination unit 113 identifies rank E as a ranked candidate for the distributor 4.

As described above, in step SA6, the smaller the number of delayed days is, the higher rank the rank determination unit 113 identifies.

Next, the rank determination unit 113 acquires the total number of sheets of the leaflet TS distributed by the distributor 4 in the past based on the total number of sheets information 1224 of the record identified in step SA2 (step SA7).

Next, the rank determination unit 113 identifies one ranked candidate for the distributor 4 from among rank A, rank B, rank C, rank D, and rank E based on the total number of sheets acquired in step SA7 (step SA8).

In step SA8, when the total number of sheets is Z1 or more, the rank determination unit 113 identifies rank A as a ranked candidate for the distributor 4. In addition, in step SA8, when the total number of sheets is less than Z1 and Z2 or more, the rank determination unit 113 identifies rank B as a ranked candidate for the distributor 4. Note that Z2 is smaller than Z1. Further, in step SA8, when the total number of sheets is less than Z2 and Z3 or more, the rank determination unit 113 identifies rank C as a ranked candidate for the distributor 4. Note that Z3 is smaller than Z2. Further, in step SA8, when the total number of sheets is less than Z3 and Z4 or more, the rank determination unit 113 identifies rank D as a ranked candidate for the distributor 4. In addition, Z4 is smaller than Z3. Further, in step SA8, when the total number of sheets is less than Z4, the rank determination unit 113 identifies rank E as a ranked candidate for the distributor 4.

In this way, in step SA8, the more the total number of sheets is the higher rank the rank determination unit 113 identifies.

Next, the rank determination unit 113 determines the lowest rank among the ranks identified in steps SA4, SA6, and SA8 as the rank of the distributor 4 (step SA9). For example, when rank B is identifies in step SA4, rank B is identifies in step SA6, and rank C is identifies in step SA8, the rank determination unit 113 determines rank C as the rank of the distributor 4 in step SA9.

Next, the rank determination unit 113 outputs, to the database management unit 114, the rank information 1222 indicating the rank determined in step SA9 in association with the distributor ID 1221 included in the record identified in step SA1 (step SA11).

The database management unit 114 identifies the associated record from the distributor management database 122 with the input distributor ID 1221 as a key, and updates the rank information 1222 of the identified record to the rank information 1222 output by the rank determination unit 113. This completes the assignment of the rank to the distributor 4.

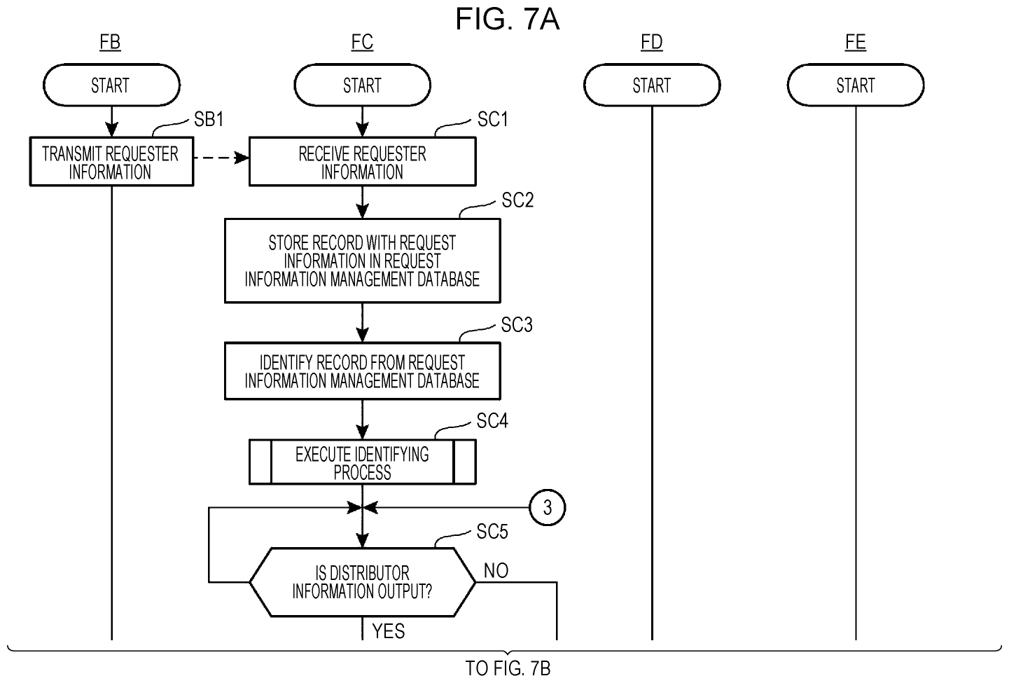

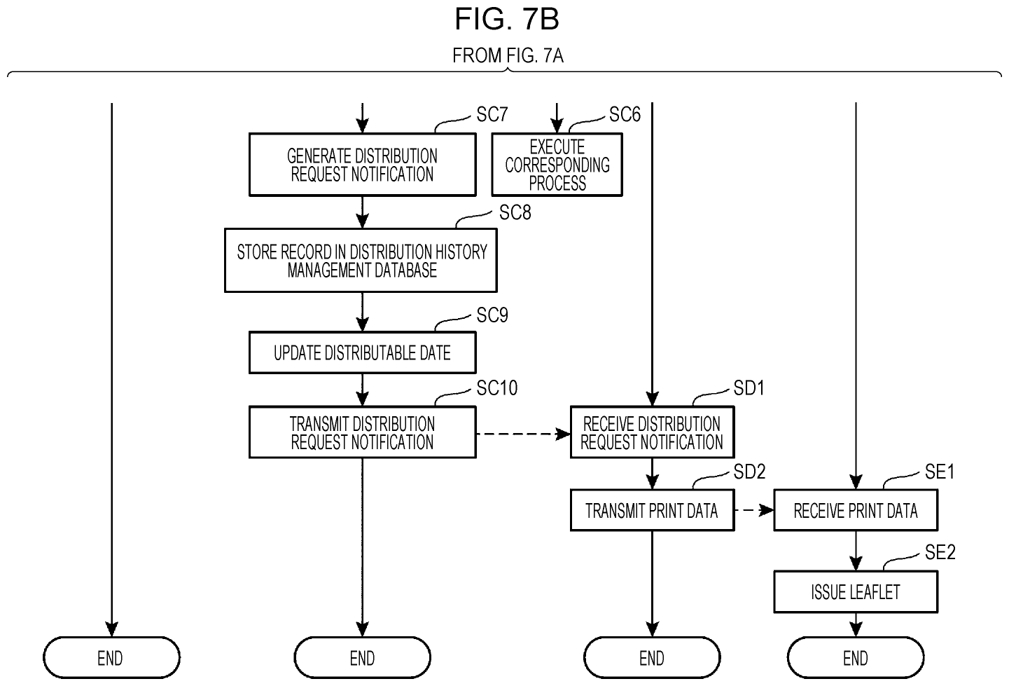

Next, the operation of the advertisement system 1000 will be described. FIGS. 7A and 7B are flowcharts showing the operation of the advertisement system 1000. In FIGS. 7A and 7B, a flowchart FB shows the operation of the advertiser PC 2. Further, a flowchart FC shows the operation of the posting server 1. Further, a flowchart FD shows the operation of the tablet terminal 5. Further, a flowchart FE shows the operation of the printer 3.

As shown in the flowchart FB, the browser execution unit 2100 of the advertiser PC 2 transmits the request information 1232 to the posting server 1 through the advertiser PC communication unit 21 according to the operation of the advertiser 2A (step SB1).

As shown in the flowchart FC, the reception unit 111 of the posting server 1 receives the request information 1232 from the advertiser PC 2 through the server communication unit 11 (step SC1).

Next, the data processing unit 116 generates a record including the request information 1232 to store the generated record in the request information management database 123 (step SC2).

Next, the identification unit 112 identifies the record stored in step SC2 from the request information management database 123 (step SC3).

Next, the identification unit 112 executes an identification process (step SC4). The identification process is a process of identifying the distributor 4 who meets the distribution condition indicated by the request information 1232 of the record identified in step SC3. Note that the identification process can be rephrased as a process of selecting the distributor 4 corresponding to the distribution condition indicated by the request information 1232 of the record identified in step SC3. To identify the distributor 4 means to identify, from the distributor management database 122, the distributor information 1229 corresponding to the distribution condition indicated by the request information 1232 of the record identified in step SC3.

FIG. 8 is a flowchart showing the operation of the posting server 1 in the identification process.

The identification unit 112 acquires the distribution desired area information 1238 from the record identified in step SC3 (step SC401).

Next, the identification unit 112 identifies, from the distributor management database 122, the distributor information 1229 including the assigned area information 1223 indicating the assigned area including the distribution desired area indicated by the distribution desired area information 1238 acquired in step SC401 (step SC402).

For example, it is assumed that the distributor management database 122 stores distributor information 1229 of the distributors 4-1, 4-2, 4-3, 4-4, and 4-5. Then, it is assumed that the distribution desired area indicated by the distribution desired area information 1238 acquired in step SC401 indicates “area A”. In this case, the identification unit 112 identifies the distributor information 1229 of the distributors 4-1, 4-2, 4-3, and 4-4 from the distributor management database 122 in step SC402.

Next, the identification unit 112 determines whether the distributor information 1229 is identified from the distributor management database 122 in step SC402 (step SC403).

When it is determined that the distributor information 1229 cannot be identified from the distributor management database 122 (step SC403: NO), the identification unit 112 executes the process of step SC5.

On the other hand, when it is determined that the distributor information 1229 has been identified from the distributor management database 122 (step SC403: YES), the identification unit 112 executes the process of step SC404.

In step SC404, the identification unit 112 identifies, from the distributor information 1229 identified in step SC402, the distributor information 1229 including the distributable date information 1226 indicating the distributable date corresponding to at least part of the distribution desired period indicated by the distribution desired period information 1236 of the record identified in step SC3.

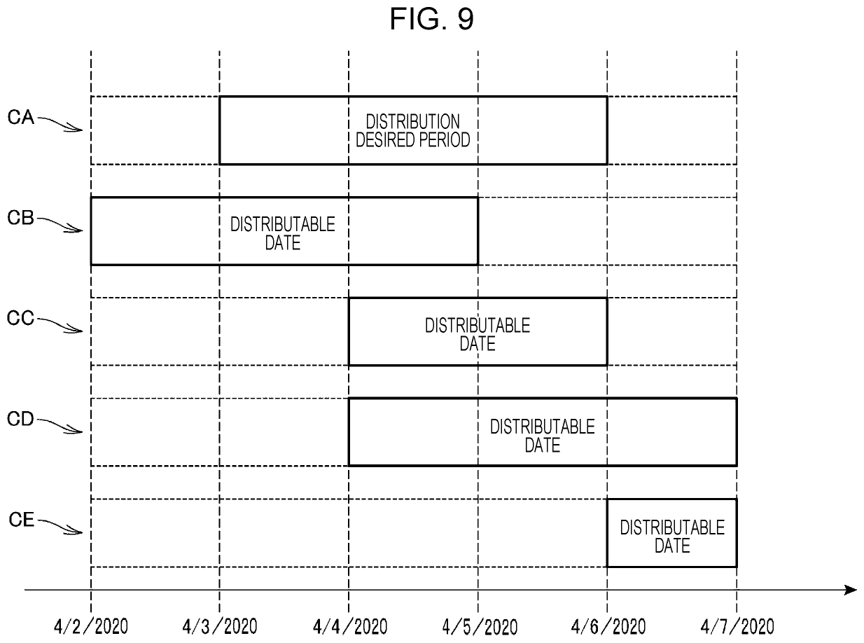

Here, the process of step SC404 will be specifically described with reference to FIG. 9. FIG. 9 is a diagram for explaining the identification of the distributor information 1229.

FIG. 9 exemplifies a case in which the distributor information 1229 for each of the distributors 4-1, 4-2, 4-3, and 4-4 is identified.

In FIG. 9, a chart CA indicates the distribution desired period indicated by the distribution desired period information 1236 of the record identified in step SC4. As shown by the chart CA, in FIG. 9, the distribution desired period is three days from Apr. 3, 2020 to Apr. 5, 2020.

In FIG. 9, a chart CB indicates the distributable date of the distributor 4-1. As shown in the chart CB, in FIG. 9, the distributable dates of the distributor 4-1 are Apr. 2, 2020, Apr. 3, 2020, and Apr. 4, 2020.

In FIG. 9, a chart CC shows the distributable date of the distributor 4-2. As shown in the chart CC, in FIG. 9, the distributable dates of the distributor 4-2 are Apr. 4, 2020 and Apr. 5, 2020.

In FIG. 9, a chart CD indicates the distributable date of the distributor 4-3. As shown in the chart CD, in FIG. 9, the distributable dates of the distributor 4-3 are Apr. 4, 2020, Apr. 5, 2020, and Apr. 6, 2020.

In FIG. 9, a chart CE indicates the distributable date of the distributor 4-4. As shown by the chart CE, in FIG. 9, the distributable date of the distributor 4-4 is Apr. 6, 2020.

The identification unit 112 identifies the distributor information 1229 including the distributable date information 1226 indicating the distributable date corresponding to at least part of the distribution desired period. In the case of FIG. 9, the distributable dates of the distributors 4-1, 4-2, and 4-3 correspond to at least part of the distribution desired period. Therefore, in the case of FIG. 9, the identification unit 112 identifies the distributor information 1229 for each of the distributors 4-1, 4-2, and 4-3.

Returning to the description of FIG. 8, the identification unit 112 determines whether the distributor information 1229 can be identified in step SC404 (step SC405).

When it is determined that the distributor information 1229 cannot be identified (step SC405: NO), the identification unit 112 executes the process of step SC5.

On the other hand, when determining that the distributor information 1229 has been identified (step SC405: YES), the identification unit 112 executes the process of step SC406.

In step SC406, the identification unit 112 identifies the distributor information 1229 from the distributor information 1229 identified in step SC404 based on the rank information 1222 and the desired number of distribution sheets information 1237.

Here, the process of step SC406 will be described in detail. The identification unit 112 identifies the distributor information 1229 including the rank information 1222 indicating the highest rank from the distributor information 1229 identified in step SC404. When there is a plurality of pieces of distributor information 1229 including the rank information 1222 indicating the highest rank, the identification unit 112 identifies one distributor information 1229 based on a predetermined standard.

Next, the identification unit 112 determines whether the distributable number of sheets indicated by the distributable number of sheets information 1227 of the one identified distributor information 1229 exceeds the desired number of distribution sheets indicated by the desired number of distribution sheets information 1237 of the record identified in step C3. When it is determined that the distributable number of sheets exceeds the desired number of distribution sheets, the identification unit 112 ends the process of step SC406.

On the other hand, when it is determined that the distributable number of sheets does not exceeded the desired number of distribution sheets, the identification unit 112 determines whether the distributor information 1229 identified in step SC404 includes unidentified distributor information 1229. When it is determined that there is no unidentified distributor information 1229, the identification unit 112 ends the process of step SC406.

On the other hand, when determining that there is the unidentified distributor information 1229, the identification unit 112 identifies the distributor information 1229 including the rank information 1222 indicating the highest rank from the unidentified distributor information 1229. When there is a plurality of pieces of the distributor information 1229 including the rank information 1222 indicating the highest rank, the above-described identification is made. Then, the identification unit 112 determines, based on the two identified pieces of distributor information 1229, that the total distributable number of sheets indicated by the distributable number of sheets information 1227 exceeds the desired number of distribution sheets indicated by the desired number of distribution sheets information 1237 of the record identified in step C3.

After that, in step SC406, the identification unit 112 repeats identification of the distributor information 1229 from among the distributor information 1229 identified in step SC404 until it is determined, based on all identified distributor information 1229, that the total distributable number of sheets indicated by the distributable number of sheets information 1227 exceeds the desired number of distribution sheets indicated by the desired number of distribution sheets information 1237 of the record identified in step C3, or until it is determined that there is no unidentified distributor information 1229.

For example, it is assumed that the distributor 4-1 is assigned rank A, the distributor 4-2 is assigned rank B, and the distributor 4-3 is assigned rank C. It is also assumed that the distributable number of sheets of the distributor 4-1 is 100, the distributable number of sheets of the distributor 4-2 is 150, and the distributable number of sheets of the distributor 4-3 is 200. Further, it is assumed that the desired number of distribution sheets is 200. In this case, the identification unit 112 identifies the distributor information 1229 of the distributors 4-1 and 4-2 in step SC406.

The identification unit 112 determines, based on all the distributor information 1229 identified in step SC406, whether the total distributable number of sheets exceeds the desired number of distribution sheets indicated by the desired number of distribution sheets information 1237 of the record identified in step SC3 (step SC407).

When making an affirmative determination in step SC407, the identification unit 112 outputs all the distributor information 1229 identified in step SC406 to the data processing unit 116 (step D508).

On the other hand, when the identification unit 112 makes a negative determination in step SC407, the presentation unit 115 executes the distribution condition changing process (step SC409). The distribution condition changing process is a process of changing the distribution condition indicated by the record identified in step SC3. Here, three processes will be described as the distribution condition changing process.

### Process 1

The presentation unit 115 performs a change, in the distribution condition, of expanding the distribution desired area. For example, when the distribution desired area of the distribution condition indicated by the record identified in step SC3 is “area A”, the presentation unit 115 expands the distribution desired area to “area A” and “area B”.

### Process 2

The presentation unit 115 performs a change, in the distribution condition, of reducing the desired number of distribution sheets. For example, when the desired number of distribution sheets of the distribution condition indicated by the record identified in step SC3 is 200, the presentation unit 115 changes the desired number of distribution sheets to 200 and 150.

### Process 3

The presentation unit 115 performs a change, in the distribution condition, of extending the distribution desired period. For example, when the distribution desired period of the distribution condition indicated by the record identified in step SC3 is “a period from Apr. 3, 2020 to Apr. 5, 2020”, the presentation unit 115 changes the distribution desired period to “a period from Apr. 3, 2020 to Apr. 6, 2020”.

Note that in step SC409, the presentation unit 115 may execute any one of the processes 1, 2, and 3, or may execute a plurality of the processes at the same time. In addition, the presentation unit 115 may execute the process 1, the process 2, and the process 3, for example, in this order each time step SC409 is performed until an affirmative determination is made in step SC411.

Based on the distribution condition changed by the presentation unit 115 in step SC409, the identification unit 112 makes the identifications same as those in steps SC402, SC404, and SC406 in the same order (step SC410).

Next, the identification unit 112 determines, based on the distributor information 1229 identified in step SC410, whether the total distributable number of sheets exceeds the desired number of distribution sheets indicated by the desired number of distribution sheets information 1237 of the record identified in step SC3 (step SC411).

When the identification unit 112 makes a negative determination in step SC411, the presentation unit 115 again executes the processes of step SC409 and the subsequent steps.

On the other hand, when the identification unit 112 makes an affirmative determination in step SC411, the presentation unit 115 presents the changed distribution condition to the advertiser PC 2 based on the address information 1234 of the record identified in step SC3 (step SC412).

In step SC412, the presentation unit 115 transmits, through the server communication unit 11, the information indicating the changed distribution condition to the advertiser PC 2. Upon receiving the information, the advertiser PC 2 displays the changed distribution condition.

Next, the presentation unit 115 determines whether the advertiser 2A has permitted distribution of the leaflet TS based on the changed distribution condition (step SC413).

When receiving the information indicating the distribution condition, the browser execution unit 2100 inquires of the advertiser 2A whether the advertiser 2A permits distribution of the leaflet TS based on the changed distribution condition. When receiving an input indicating permission of the distribution, the browser execution unit 2100 transmits information indicating that the distribution is permitted to the posting server 1. In addition, when receiving an input indicating no-permission of the distribution, the browser execution unit 2100 transmits information indicating that the distribution is not permitted to the posting server 1. The presentation unit 115 makes an affirmative determination in step SC413 when receiving information indicating that the distribution is permitted, and makes a negative determination in step SC413 when receiving information indicating that the distribution is not permitted.

When determining that the advertiser 2A has permitted the distribution of the leaflet TS based on the changed distribution condition (step SC413: YES), the presentation unit 115 outputs, to the data processing unit 116, all the distributor information 1229 identified in step SC410 (step SC414).

On the other hand, when determining that the advertiser 2A does not permit the distribution of the leaflet TS based on the changed distribution condition (step SC413: NO), the presentation unit 115 determines whether to cancel a change in the distribution condition (step SC415).

When receiving an input indicating no-permission of the distribution of the leaflet TS based on the changed distribution condition, the browser execution unit 2100 inquires whether the change in the distribution condition is cancelled. Upon receiving an input indicating the cancellation, the browser execution unit 2100 transmits information indicating the cancellation to the posting server 1. In addition, when receiving an input indicating no cancellation, the browser execution unit 2100 transmits information indicating no cancellation to the posting server 1. The presentation unit 115 makes an affirmative determination in step SC415 when receiving information indicating the cancellation, and makes a negative determination in step SC415 when receiving information that indicates no cancellation.

When determining that the change in the distribution condition is not cancelled (step SC415: NO), the presentation unit 115 again executes the processes in step SC409 and the subsequent steps.

On the other hand, when determining that the change in the distribution condition is cancelled (step SC415: YES), the presentation unit 115 executes the corresponding process (step SC416). Examples of the corresponding process include a process of notifying the advertiser 2A that the desired number of distribution sheets of the leaflet TS cannot be distributed, and a process of suggesting that the advertiser 2A reduce the fee for distributing the leaflet TS.

Returning to the description of the flowchart in FIGS. 7A and 7B, when the identification unit 112 executes the identification process, the data processing unit 116 determines whether the identification unit 112 has output the distributor information 1229 (step SC5).

When determining that the identification unit 112 has not output the distributor information 1229 (step SC5: NO), the data processing unit 116 executes the corresponding process (step SC6). An example of the corresponding process is a process of notifying the advertiser 2A that the desired number of distribution sheets of the leaflet TS cannot be distributed.

On the other hand, when determining that the distributor information 1229 is output (step SC5: YES), the data processing unit 116 generates a distribution request notification (step SC7).

Here, the process of step SC7 will be specifically described. For example, it is assumed that the identification unit 112 outputs the distributor information 1229 of the distributors 4-1 and 4-2 to the data processing unit 116. In addition, it is assumed that the distribution condition when the distributor information 1229 of the distributors 4-1 and 4-2 is identified is that the desired number of distribution sheets is 200, the distribution desired period is from Apr. 3, 2020 to Apr. 6, 2020, and the distribution desired area is “area A”. Further, it is assumed that the distributor information 1229 of the distributor 4-1 includes the assigned area information 1223 indicating “area A”, the distributable date information 1226 indicating a period from Apr. 2, 2020 to Apr. 4, 2020, and the distributable number of sheets information 1227 indicating 100 sheets. It is assumed that the distributor information 1229 of the distributor 4-2 includes the assigned area information 1223 indicating “area A”, the distributable date information 1226 indicating a period from Apr. 4, 2020 to Apr. 5, 2020, and the distributable number of sheets information 1227 indicating 100 sheets.

In this case, for example, the data processing unit 116 generates, as a distribution request notification transmitted to the tablet terminal 5-1 of the distributor 4-1, a distribution request notification that includes a distribution start date and time of Apr. 3, 2020, a distribution end date and time of Apr. 6, 2020, a target number of distribution sheets of 100, and print data based on the record identified in step SC3. Also in this case, the data processing unit 116 generates, as a distribution request notification transmitted to the tablet terminal 5-2 of the distributor 4-2, a distribution request notification that includes a distribution start date and time of Apr. 4, 2020, a distribution end date and time of Apr. 6, 2020, a target number of distribution sheets of 100, and print data based on the record identified in step SC3.

Note that the data processing unit 116 may change the target number of distribution sheets according to the rank of the distributor 4 when generating the distribution request notification.

Next, the data processing unit 116 generates records, to be stored in the distribution history management database 124, the number of which is equal to the number of generated distribution request notifications to store the records in the distribution history management database 124 (step SC8).

Here, the process of step SC8 will be specifically described. For example, it is assumed that the data processing unit 116 generates, as a distribution request notification to be transmitted to the tablet terminal 5-1 of the distributor 4-1, a distribution request notification including the distribution start date and time information 1242 indicating Apr. 3, 2020, the distribution end date and time information 1243 indicating Apr. 6, 2020, and the target number of distribution sheets information 1247 indicating 100 sheets.

In this case, the data processing unit 116 generates and stores the next record for the distributor 4-1. That is, the data processing unit 116 generates and stores the record including the distributor ID 1221 of the distributor 4-1, the request information ID 1231 of the record identified in step SC3, the distribution start date and time information 1242 indicating Apr. 3, 2020, the distribution end date and time information 1243 indicating the Apr. 6, 2020, the actual start date and time information 1244 and the actual end date and time information 1245 with no date and time set, the distribution area information 1246 indicating “area A”, the target number of distribution sheets information 1247 indicating 100 sheets, the number of distribution completion sheets information 1248 with the number of sheets being not set, and the distribution status information 1249 indicating “before distribution”.

Next, the database management unit 114 updates the distributable date information 1226 (step SC9).

Here, the process of step SC9 will be specifically described. For example, it is assumed that the data processing unit 116 generates, as a distribution request notification to be transmitted to the tablet terminal 5-1 of the distributor 4-1, a distribution request notification including the distribution start date and time information 1242 indicating Apr. 3, 2020, the distribution end date and time information 1243 indicating Apr. 6, 2020, and the target number of distribution sheets information 1247 indicating 100 sheets.

In this case, the database management unit 114 updates the distributable date indicated by the distributable date information 1226 of the distributor information 1229 of the distributor 4-1 to the distributable date that does not include a period from Apr. 3, 2020 to Apr. 6, 2020.

The process of step SC9 is executed as described above, so that a plurality of distribution request notifications with distribution periods overlapping is not transmitted to the one distributor 4.

Next, the communication controller 117 transmits the distribution request notification through the server communication unit 11 (step SC10).

With reference to the flowchart FD, the application execution unit 5100 of the tablet terminal 5 receives the distribution request notification through the terminal network communication unit 51 (step SD1).

Next, the application execution unit 5100 transmits the print data included in the distribution request notification to the printer 3 through the terminal communication unit 52 (step SD2).

Referring to the flowchart FE, the printer controller 30 of the printer 3 receives the print data through the printer communication unit 31 (step SE1). Then, the printer controller 30 controls the printing unit 32 to perform printing based on the print data to issue the leaflet TS (step SE2).

As described above, the advertisement system 1000 issues the leaflet TS by the printer 3 of the distributor 4 who distributes the leaflet TS. The advertisement system 1000 includes the server storage unit 120 that stores distributor information 1229, the reception unit 111 that receives, from an advertiser 2A, an advertisement request including a distribution condition related to a distribution of the leaflet, the identification unit 112 that identifies the distributor 4 who satisfies the distribution condition included in the advertisement request received by the reception unit 111 based on the distributor information 1229 stored in the server storage unit 120, and the server communication unit 11 that transmits, to the printer 3 of the distributor 4 identified by the identification unit 112, print data instructing issuance of the leaflet TS based on the advertisement request received by the reception unit 111.

In addition, a method of controlling the advertisement system 1000 includes storing a plurality of pieces of distributor information 1229, receiving, from the advertiser 2A, the advertisement request including the distribution condition related to the distribution of the leaflet TS, identifying the distributor 4 who meets the distribution condition included in the received advertisement request based on the stored distributor information 1229, and transmitting, to the printer 3 of the identified distributor 4, the print data instructing issuance of the leaflet TS based on the advertisement request received by the reception unit 111.

The posting server 1 includes the server storage unit 120 that stores distributor information 1229, the reception unit 111 that receives, from an advertiser 2A, an advertisement request including a distribution condition related to a distribution of the leaflet, the identification unit 112 that identifies the distributor 4 who satisfies the distribution condition included in the advertisement request received by the reception unit 111 based on the distributor information 1229 stored in the server storage unit 120, and the server communication unit 11 that transmits, to the printer 3 of the distributor 4 identified by the identification unit 112, print data instructing issuance of the leaflet TS based on the advertisement request received by the reception unit 111.

According to the advertisement system 1000, the method of controlling the advertisement system 1000, and the posting server 1, the distributor 4 according to the distribution condition of the advertiser 2A can be appropriately and automatically identified, so that the leaflet TS can be easily distributed according to the distribution condition of the advertiser 2A.

The distributor information 1229 includes the assigned area information 1223 indicating the assigned area. The distribution condition includes a distribution desired area that is an area in which the advertiser 2A desires the distributor to distribute the leaflet TS. The identification unit 112 identifies the distributor information 1229 including the assigned area information 1223 indicating the assigned area including the distribution desired area.

According to this, the distributor 4 having the distribution area desired by the advertiser 2A as the assigned area can be automatically identified, so that the leaflet TS can be easily distributed in the distribution area desired by the advertiser 2A.

Distributor information 1229 includes distributable date information 1226 indicating the distributable date. The distribution condition includes the distribution desired period which is a period in which the advertiser 2A desires the distributor to distribute the leaflet TS. The identification unit 112 identifies the distributor information 1229 including the distributable date information 1226 indicating the distributable date corresponding to at least part of the distribution desired period.

According to this, the distributor 4 who can distribute the leaflet TS in the distribution period desired by the advertiser 2A can be automatically identified, the leaflet TS can be easily distributed in the distribution period desired by the advertiser 2A.

The distributor information 1229 includes the rank information 1222 indicating the rank of the distributor 4 according to the distribution record. The identification unit 112 identifies the distributor information 1229 by giving higher priority to the distributor information 1229 in which the rank indicated by the rank information 1222 is higher.

According to this, it is possible to automatically prioritize and identify the distributor 4 who is highly likely to perform distribution according to the distribution condition of the advertiser 2A. Therefore, the leaflet TS can be easily and reliably distributed according to the distribution condition of the advertiser 2A.

The advertisement system 1000 includes the rank determination unit 113 that determines the rank based on at least one of the number of sheets actually distributed by the distributor 4 with respect to the target number of sheets to be distributed, the number of days by which a start of a distribution of the leaflet TS is delayed, and the total number of sheets distributed by the distributor 4 in the past.

According to this, the rank of the distributor 4 can be determined based on the distribution record of at least one of the number of sheets actually distributed by the distributor 4 with respect to the target number of sheets to be distributed, the number of days by which a start of a distribution of the leaflet TS is delayed, and the total number of sheets distributed by the distributor 4 in the past.

The advertisement system 1000 includes the presentation unit 115 that presents, to the advertiser 2A, the distribution condition which enables the identification unit 112 to identify the distributor information 1229 that satisfies the distribution condition when the identification unit 112 is not enabled to identify the distributor information 1229 that satisfies the distribution condition.

According to this, when the leaflet TS cannot be distributed according to the distribution condition when the advertisement request is made, an alternative plan of the distribution condition can be presented to the advertiser 2A to provide the advertisement system 1000 having high convenience for the advertiser 2A.

The embodiment described above is merely an aspect of the present disclosure, and any modification and application can be made within the scope of the present disclosure.

For example, in the embodiment described above, the leaflet TS is not distributed when a negative determination is made in step SC403 and step SC404, but the process may proceed to step SC409 and the distribution condition changing process may be executed when a negative determination is made in step SC403 and step SC404.

Further, for example, in the above-described embodiment, the stationary printer 3 is illustrated, but the portable printer 3 may be used. The printer 3 is not limited to a serial type ink jet printer, and may be a line type ink jet printer. The printing method of the printer 3 is not limited to the ink jet method.

Further, the functions of the server controller 10, the advertiser PC controller 20, the terminal controller 50, and the printer controller 30 may be implemented by a plurality of processors or semiconductor chips.

Further, respective units shown in FIGS. 2A and 2B are an example, and a specific mounting form is not limited in particular. That is, it is not necessarily required to implement hardware corresponding to respective units, but it is of course possible to construct a configuration in which the functions of the respective units are implemented by executing a program by one processor. In addition, in the above embodiments, part of the functions implemented by software may be implemented by hardware, or part of the functions implemented by hardware may be implemented by software. In addition, specific detailed configurations of other units of the posting server 1, the advertiser PC 2, the tablet terminal 5, and the printer 3 can be changed in any manner without departing from the scope of the present disclosure.

Further, for example, the step units of the operations shown in FIGS. 6, 7A, 7B, and 8 are divided in accordance with the main processing contents in order to facilitate understanding of the operations of the respective devices of the advertisement system 1000. The present disclosure is not limited by the method and name of the division of the processing stage. Depending on the processing contents, the process may be divided into more step units. Further, one step unit may be divided so as to include more processes. In addition, the order of the steps may be changed as appropriate within the scope of the present disclosure.

What is claimed is:

1. An advertisement system that issues an advertising medium by a printing apparatus of a distributor who distributes the advertising medium, the advertisement system comprising:
a storage unit that stores distributor information about the distributor;
a reception unit that receives, from an advertiser, an advertisement request including a distribution condition related to a distribution of the advertising medium;
a identification unit that identifies the distributor that satisfies the distribution condition included in the advertisement request received by the reception unit based on the distributor information stored in the storage unit; and
a transmission unit that transmits, to the printing apparatus of the distributor identified by the identification unit, print data instructing issuance of the advertising medium based on the advertisement request received by the reception unit.

2. The advertisement system according to claim 1, wherein
the distributor information includes distributable area information indicating a distributable area in which the distributor is enabled to distribute the advertising medium, wherein
the distribution condition includes a distribution desired area that is an area in which the advertiser desires the distributor to distribute the advertising medium, and wherein
the identification unit identifies the distributor information including the distributable area information indicating the distributable area including the distribution desired area.

3. The advertisement system according to claim 1, wherein
the distributor information includes distributable date information indicating a distributable date that is a date when the distributor is enabled to distribute the advertising medium, wherein
the distribution condition includes a distribution desired period that is a period in which the advertiser desires the distributor to distribute the advertising medium, and wherein
the identification unit identifies the distributor information including the distributable date information indicating the distributable date corresponding to at least part of the distribution desired period.

4. The advertisement system according to claim 2, wherein
the distributor information includes rank information indicating a rank of the distributor according to a distribution record, and wherein
the identification unit identifies the distributor information by giving higher priority to the distributor information in which the rank indicated by the rank information is higher.

5. The advertisement system according to claim 4, further comprising:
a rank determination unit that determines the rank based on at least one of the number of sheets actually distributed by the distributor with respect to a target number of sheets to be distributed, the number of days by which a start of a distribution of the advertising medium is delayed, and a total number of sheets distributed by the distributor in the past.

6. The advertisement system according to claim 1, further comprising:
a presentation unit that presents, to the advertiser, the distribution condition which enables the identification unit to identify the distributor information that satisfies the distribution condition when the identification unit is not enabled to identify the distributor information that satisfies the distribution condition.

7. A server that issues an advertising medium by a printing apparatus of a distributor who distributes the advertising medium, the server comprising:
a storage unit that stores distributor information about the distributor;
a reception unit that receives, from an advertiser, an advertisement request including a distribution condition related to a distribution of the advertising medium;
a identification unit that identifies the distributor that satisfies the distribution condition included in the advertisement request received by the reception unit based on the distributor information stored in the storage unit; and
a transmission unit that transmits, to the printing apparatus of the distributor identified by the identification unit, print data instructing issuance of the advertising medium based on the advertisement request received by the reception unit.

8. A method of controlling an advertisement system that issues an advertising medium by a printing apparatus of a distributor who distributes the advertising medium, the method comprising:
storing distributor information about the distributor;
receiving, from an advertiser, an advertisement request including a distribution condition related to a distribution of the advertising medium;
identifying, from the stored distributor information, the distributor that satisfies the distribution condition included in the received advertisement request; and
transmitting, to the printing apparatus of the identified distributor, print data instructing issuance of the advertising medium based on the received advertisement request.
